(19) United States
(12) Patent Application Publication
(10) Pub. No.: US 2003/0172382 A1
(43) Pub. Date: Sep. 11, 2003

(54) Method and apparatus for searching for broadcasting program information

(75) Inventor: Kyung-ah Kim, Seoul (KR)

Correspondence Address: SUGHRUE MION, PLLC, 2100 Pennsylvania Avenue, NW, Washington, DC, 20037-3213, US

(73) Assignee: SAMSUNG ELECTRONICS CO., LTD.

(21) Appl. No.: 10/338,024

(22) Filed: Jan. 8, 2003

(30) Foreign Application Priority Data
Jan. 9, 2002 (KR) 2002-1193

(51) Int. Cl. G06F 13/00

(52) U.S. Cl. 725/53

(57) ABSTRACT

A method and apparatus is provided for simply and easily searching for information relating to a broadcasting program desired by a user by providing keywords corresponding to proper information included in detailed information relating to received broadcasting programs. If detailed information relating to the broadcasting programs is received, at least one keyword for each of the broadcasting programs is detected from the received detailed information relating to the broadcasting programs. Then, a broadcasting program desired by a user is searched using the detected keywords. Accordingly, since a user has only to select a keyword to search for information relating to the desired broadcasting program, information searching becomes simplified. In addition, since the user uses keywords provided by a system, the user does not need to know or determine a proper keyword in advance.

### BACKGROUND OF THE INVENTION

This application claims the priority of Korean Patent Application No. 2002-1193, filed Jan. 9, 2002, in the Korean Intellectual Property Office, the disclosure of which is incorporated herein in its entirety by reference.

1. Field of the Invention

The present invention relates to a method and apparatus for searching for broadcasting program information, and more particularly, to a method and apparatus for easily searching for information relating to a broadcasting program desired by a user in a receiving system that can receive detailed broadcasting program information.

2. Description of the Related Art

Some related art systems among ground wave receiving systems can receive and store an electric program guide (EPG), which is regularly transmitted by a broadcasting station. The related art EPG, which is a guide for programs that are transmitted by broadcasting stations, includes broadcasting program titles, broadcasting program channel numbers, broadcasting program broadcasting times, and the detailed descriptions or contents of the broadcasting programs. Accordingly, the related art ground wave receiving system allows a user to search for detailed information regarding receivable broadcasting programs from the stored EPG information.

A search mode based on text input and a category search mode have been proposed as a method of searching for information of broadcasting programs. In the related art search mode based on text input, a user inputs a keyword (or keyword) associated with a broadcasting program that the user wishes to search using a wireless keyboard that can communicate with a receiving system. Alternatively, as shown in FIG. 1A, a keyboard screen is displayed on a receiving system using a remote controller, and a desired keyword is typed on the keyboard screen by clicking keys. Thereafter, a search key is pushed or clicked to search for information relating to the desired broadcasting program from stored EPG information based on the input keyword. The search result is displayed in a format as shown in FIG. 1B.

However, the above-described search mode based on text input has various problems and disadvantages. For example, but not by way of limitation, a significantly long time is required when a user not accustomed to using a keyboard or uses a remote controller inputs a keyword. Also, to effectively use the above-described search mode based on text input, a user must have been previously be aware of the keyword associated with a program desired to be searched. Hence, when a user neither knows nor can determine an appropriate keyword associated with a program desired to be searched, it may be necessary to repeat an input of arbitrary keywords and a search for information relating to a desired program using the input keyword.

It is a further problem of the related art that when the above-described search mode based on text input is adopted, information relating to a broadcasting program associated with the input keyword may not be found. In other words, when information associated with the input keyword does not exist within stored EPG information, a search result that no appropriate information is found is output.

On the other hand, the related art category search mode is implemented as shown in FIG. 1C. When a category “sports” is clicked among a plurality of category items, a sub-screen corresponding to the clicked category is displayed. Then, when an item “golf” is clicked among items existing on the displayed sub-screen, information regarding golf-related broadcasting programs is searched from the stored EPG information. A search result is displayed as shown in FIG. 1B.

However, to effectively use the related art category search mode, a user must also be aware of the category corresponding to the program to be searched. Hence, when the user neither knows nor can determine an appropriate category associated with a program to be searched, a repetition of a selection of arbitrary categories and a search for information relating to the desired program using the selected category could be necessary, similar to the situation encountered when the above-described search mode based on text input is adopted.

In addition, since the related art category items are pre-determined using broadcasting programs predicted to be provided from broadcasting stations, information associated with a program corresponding to the selected category item may not exist within the stored EPG information as is the case when the above-described search mode based on text input is adopted.

### SUMMARY OF THE INVENTION

The present invention provides a method and apparatus for simply and easily searching for information relating to a broadcasting program desired by a user by providing keywords based on proper information included in the detailed information relating to received broadcasting programs.

The present invention also provides a method and apparatus for searching for desired broadcasting program information according to a search mode selected among a search mode using keywords detected in the detailed information, a search mode based on text input, and a category search mode.

According to an aspect of the present invention, there is provide a method of searching for information relating to broadcasting programs, in which, first, at least one keyword for each of the broadcasting programs is detected from received detailed information relating to the broadcasting programs, and then a desired broadcasting program is searched using the detected keyword.

Preferably, the keyword is a proper noun.

It is also preferable that in the keyword detection step, information corresponding to a proper noun is detected as the at least one keyword from the detailed information relating to broadcasting programs.

Preferably, the searching step includes: displaying a screen composed of the at least one keyword upon a request for a search for information relating to one of said broadcasting programs; and searching for the received detailed information using a keyword selected from the at least one displayed keyword.

It is preferable that the keyword detection step further includes storing the received detailed information and storing the at least one detected keyword.

According to another aspect of the present invention, there is provided a method of searching for information relating to broadcasting programs, in which detailed information relating to the broadcasting programs is received and stored. Next, at least one keyword for each of the broadcasting programs is detected from the received detailed information and storing the detected keywords. Then, if one among a search mode using the detected keywords, a search mode based on text input, and a search mode based on category selection is requested to perform a search, the detailed information relating to a desired broadcasting program is searched based on the requested search mode. Then, the searched information relating to the broadcasting programs is displayed.

According to still another aspect of the present invention, there is provide an apparatus for searching for information relating to broadcasting programs, in which a detailed information detector detects detailed information relating to the broadcasting programs from a received broadcasting signal. A keyword detector detects at least one keyword from the detailed information detected by the detailed information detector. If a search is requested for one of the broadcasting programs, a system controller controls the keyword detector to output the at least one detected keyword and displays the keyword output from the keyword detector. Also, if a keyword is selected from the at least one displayed keyword, the system controller displays the detailed information relating to broadcasting programs including the selected keyword. A graphics engine is controlled by the system controller in order to transform the at least one detected keyword and the detected detailed information into information that can be displayed. A display unit displays the at least one keyword and detailed information provided by the graphics engine.

Preferably, the apparatus further includes a first storage unit storing the detailed information and a second storage unit storing the at least one keyword.

According to still another aspect of the present invention, there is provide an apparatus for searching for information relating to broadcasting programs, in which a detailed information detector detects detailed information relating to the broadcasting programs from a received broadcasting signal. A keyword detector detects at least one keyword from the detailed information received from the detailed information detector. If one among a search mode using the at least one detected keyword, a search mode based on text input, and a search mode based on category selection is requested by a user, a system controller controls the apparatus so that information relating to a desired one of the broadcasting programs is searched from the detailed information according to the requested search mode. A graphics engine is controlled by the system controller so that image information for the search mode using the at least one keyword, image data for the search mode based on text input, image data for the category search mode, and image data relating to searching results are each transformed into data that can be displayed. A display unit displays the image data provided by the graphics engine.

Preferably, a user requests a search to obtain a desired one of the broadcast programs.

Optionally, an output of the text input search mode may be used in the keyword search mode.

Additionally, the system controller may choose between the search modes simultaneously or sequentially.

### BRIEF DESCRIPTION OF THE DRAWINGS

The above and other aspects and advantages of the present invention will become more apparent by describing in detail preferred embodiments thereof with reference to the attached drawings in which:

FIGS. 1A through 1C are screens explaining a related art method of searching for broadcasting program information;

FIG. 2 is a block diagram of a receiving system including an apparatus for searching for broadcasting program information according to a non-limiting, exemplary embodiment of the present invention;

FIG. 3 is a flowchart illustrating a method of searching for broadcasting program information according to a non-limiting, exemplary embodiment of the present invention; and

FIGS. 4A and 4B are screens explaining the method of FIG. 3.

### DETAILED DESCRIPTION OF THE INVENTION

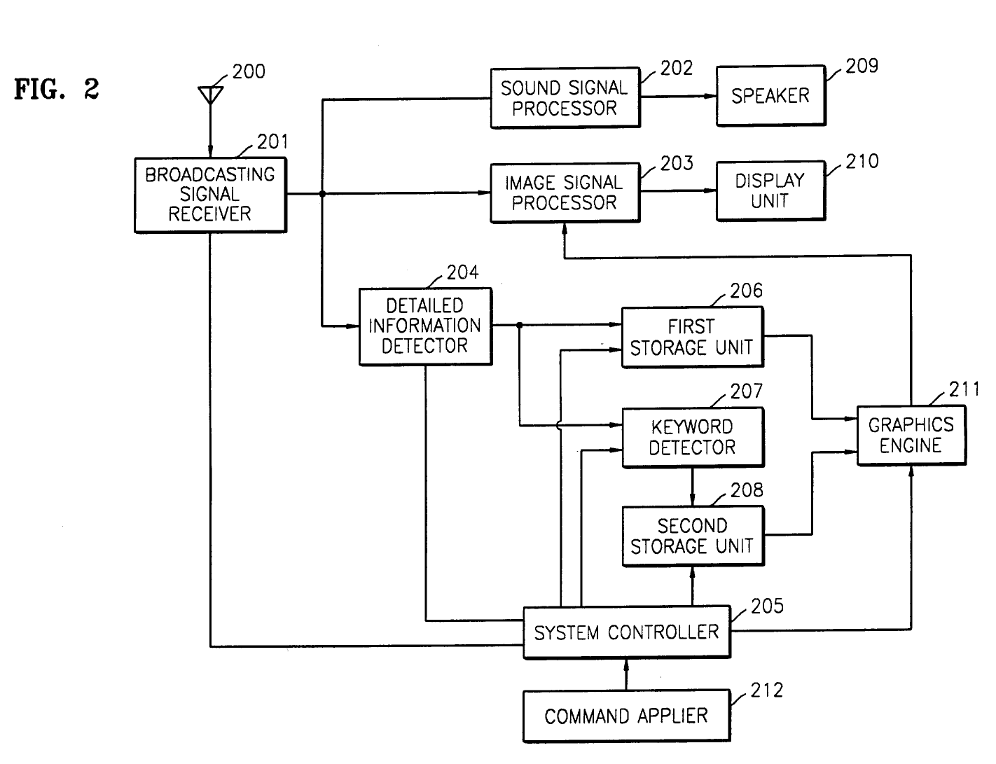

Referring to FIG. 2, a receiving system including an apparatus according to the present invention for searching for broadcasting program information includes (but is not limited to) an antenna 200, a broadcasting signal receiver 201, a sound signal processor 202, an image signal processor 203, a detailed information detector 204, a system controller 205, a first storage unit 206, a keyword detector 207, a second storage unit 208, a speaker 209, a display unit 210, a graphics engine 211, and a command applier 212.

The broadcasting signal receiver 201, which serves as a tuner, is controlled by the system controller 205 and receives a broadcasting signal for a tuned channel among received broadcasting signals via the antenna 200. The received broadcasting signal corresponds to information that includes broadcasting programs and the detailed information associated with the broadcasting programs. For example, but not by way of limitation, the detailed information may include the above-described related art EPG. The broadcasting signal receiver 201 transmits a sound signal included in the received broadcasting signal to the sound signal processor 202 and an image signal included in the received broadcasting signal to the image signal processor 203.

The sound signal processor 202 is the same as a sound signal processing circuit that is included in a related art receiving system. If the receiving system is a digital TV or a settop box similar to the digital TV, the sound signal processor 202 decodes the received sound signal and converts the decoded sound signal into analog sound data. The sound data output from the sound signal processor 202 must be recognizable by a user (or a viewer) via the speaker 209.

The image signal processor 203 processes the image signal received from the broadcasting signal receiver 201 so that the image signal is displayed on the display unit 210. If the receiving system is the aforementioned digital TV or settop box, the image signal processor 203 decodes the received image signal and RGB-encodes the decoded image signal into an image signal that can be displayed on the display unit 210.

In particular, the image signal processor 203 inserts image data, which includes information such as detailed information received from the graphics engine 211, into an image signal that is to be produced, and transmits the image signal with the inserted image data to the display unit 210. The image data can be displayed either over the entire screen of the display unit 210 or on part of the screen of the display unit 210.

The detailed information detector 204 detects detailed information from the image signal received from the broadcasting signal receiver 201. Since the detailed information is transmitted while being included in a particular area of an image signal packet, the detailed information can be obtained by decoding the information included in that particular area. The detailed information is related to the receivable broadcasting programs. In case of ground wave receiving systems, the detailed information corresponds to an EPG. The detected detailed information is transmitted to the first storage unit 206 and the keyword detector 207.

The first storage unit 206 stores the received detailed information and is used when the system controller 205 attempts to search for the detailed information related to a desired program using a keyword selected according to the present invention as described herein, a keyword input in an existing search mode based on text input, or a category selected in an existing category search mode. The detailed information related to the desired broadcasting program found by the system controller 205 is output to the graphics engine 211.

The keyword detector 207 detects keywords from the detailed information received according to a determined standard. If the determined standard defines information corresponding to proper nouns to be detected from the detailed information, the keyword detector 207 detects as a keyword any information corresponding to the proper noun from the received detailed information. For example, but not by way of limitation, the information corresponding to proper nouns can be program titles or main actors' names. Such detected keywords are stored in the second storage unit 208.

If the system controller 205 requests the second storage unit 208 to output stored keywords, the second storage unit 208 outputs all of the stored keywords to the graphics engine 211. The keywords stored in the second storage unit 208 can be periodically updated by the system controller 205, or updated at any time in consideration of the received detailed information.

The graphics engine 211 receives the detailed information related to broadcasting programs from the first storage unit 205 and the keywords from the second storage unit 208. Thereafter, the graphics engine 211, controlled by the system controller 205, transforms the received information and keywords into analog image data that can be displayed on the display unit 210. Accordingly, the analog image data can be immediately inserted into the image signal in the image signal processor 203.

In addition to inputting a search mode requesting command according to the present invention, data and commands necessary to use a related art search mode based on text input, and data and commands necessary to use a related art category search mode, the command applier 212 can input data and commands necessary to perform other operations of the receiving system.

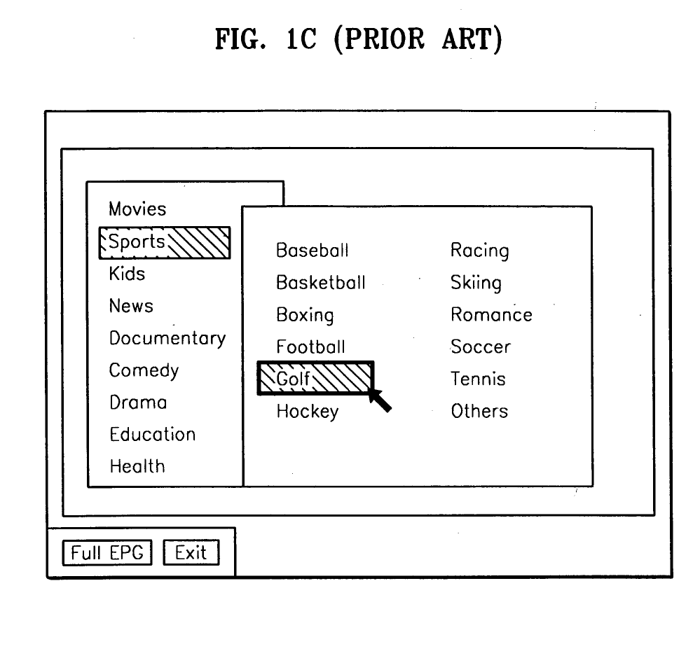

Depending on the information received from the command applier 212, the system controller 205 controls the receiving system so that the first storage unit 206 is searched for detailed information relating to a desired broadcasting program using the keywords stored in the second storage unit 208; a search mode based on text input as described above with reference to FIGS. 1A and 1B; or a category search mode as described above with reference to FIGS. 1C and 1B. The system controller 205 also controls the second storage unit 208 and the graphics engine 211 so that an image composed of the keywords stored in the second storage unit 208 is displayed on the display unit 210, and controls the first storage unit 206 and the graphics engine 211 so that the detected detailed information relating to the desired broadcasting program is displayed on the display unit 210.

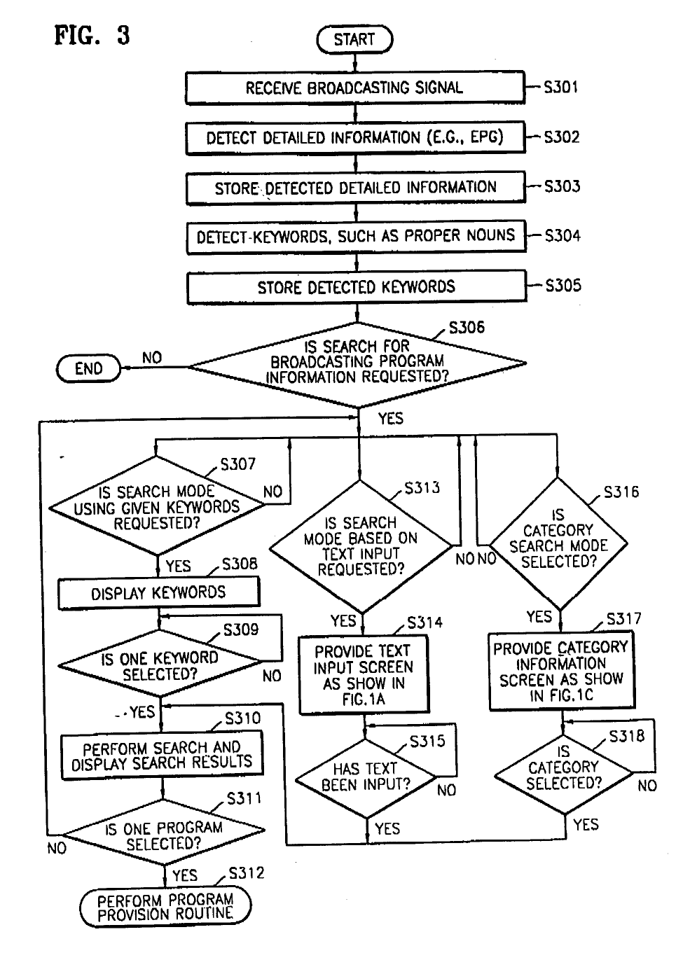

FIG. 3 is a flowchart illustrating a method of searching for broadcasting program information according to a preferred embodiment of the present invention. In step S301, a broadcasting signal for a tuned channel or a tuned broadcasting station is received among broadcasting signals received via the antenna 200.

In step S302, detailed information is detected from the received broadcasting signal. The detailed information is detected in substantially the same way as the detailed information detector 204 of FIG. 2. In step S303, the detected detailed information is stored in the first storage unit 206.

In step S304, keywords are detected from the detected detailed information. The keywords are detected in substantially the same way as those of the keyword detector 207 of FIG. 2. That is, all information corresponding to e.g., proper nouns is detected as keywords from the detected detailed information. In step S305, the detected keywords are stored in the second storage unit 208.

In step S306, it is determined whether broadcasting program information is requested to be searched. If it is determined in step S306 that an information search has been requested, it is determined at step S307 whether a search mode using given keywords stored in the second storage unit 208 is requested. Here, the search mode using given keywords is a search mode according to a non-limiting exemplary embodiment of the present invention. The given keywords denote keywords that a receiving system provides to a user who wants to search for information related to broadcasting programs.

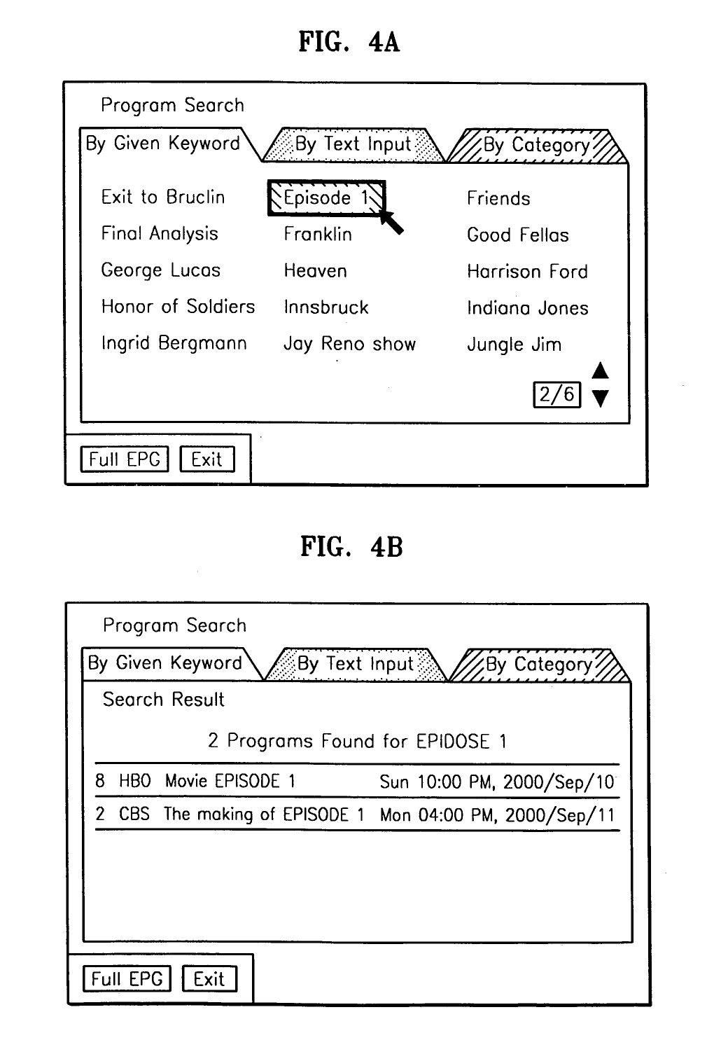

If it is determined in step S307 that the user has requested the search mode using the given keywords, all of the keywords stored in the second storage unit 208 are transmitted to the graphics engine 211, and the graphic engine 211 produces image data composed of keywords, in step S308. The produced image data is inserted into the original image in the image signal processor 203, and the resultant image is displayed on the display unit 210. A non-limiting example of a screen composed of keywords corresponding to proper nouns displayed on the display unit 210 is shown in FIG. 4A. However, the present invention is not limited to keywords based on proper nouns. The screen of FIG. 4A can be displayed over the entire screen of the display unit 210, or a portion thereof.

In step S309, it is determined whether a keyword has been selected from a keyword screen as shown in FIG. 4A. If it is determined in step S309 that a keyword has been selected, the system controller 205 searches for the detailed information relating to broadcasting programs from the first storage unit 206 using the selected keyword, in step S310. The search can be implemented so that all of the detailed information relating to broadcasting programs that include the selected keyword is searched. The detailed information relating to broadcasting programs searched from the first storage unit 206 is transmitted to the graphics engine 211.

Thereafter, as shown in FIG. 4B, the results of the search for the detailed information relating to broadcasting programs are displayed on the display unit 210. The screen of FIG. 4B shows detailed information relating to two broadcasting programs found based on a keyword “Episode 1” selected in FIG. 4A.

If a program desired to be tuned is selected from the displayed search results in step S311, a program provision routine is performed at step S312. However, if a program is not selected from the displayed search results in step S311, the method goes back to step S306. Also, if it is determined in step S307 that the search mode using given keywords is not selected, the method goes back to step S306.

In step S313, it is determined whether a search mode based on text input is requested. If it is determined in step S313 that the search mode based on text input has been requested, a text (keyword) input screen as shown in FIG. 1A is provided, or a screen (not shown) where only a keyword can be input is provided, in step S314.

If it is determined in step S315 that a text (keyword) is input, the method goes back to step S310, in which detailed information related to broadcasting programs are searched based on the input keyword, and the search results are displayed as shown in FIG. 1C. Input of the text information is achieved via the command applier 212, which may be a remote controller or a wireless keyboard, but is not limited thereto. If it is determined in step S313 that the search mode based on text input has not been requested, the method goes back to step S306.

In step S316, it is determined whether a category search mode is requested. If it is determined in step S316 that the category search mode has been requested, a category information screen as shown in FIG. 1C is provided to be displayed on the display unit 210, in step S317. More specifically, the system controller 205 provides pre-stored category information to the graphics engine 211, which processes the category information so that the category information may be displayed as a screen for keywords and detailed information on the display unit 210. Alternatively, the category information can be stored in a storage unit (not shown) installed outside the system control unit 205.

In step S318, it is determined whether a category has been selected from the category information screen as shown in FIG. 1C. If it is determined in step S318 that a category has been selected, the method proceeds to step S310, in which the system controller 205 searches for detailed information relating to the broadcasting programs that belong to the selected category from the first storage unit 206. The search results are output in the same manner as in the other search modes.

If it is determined in step S316 that the category search mode has not been requested, the method is concluded. However, the method may also go to step S301 at this point.

The aforementioned determinations in FIG. 3 are performed in the system controller 205, which receives information necessary for the determinations via the command applier 212. In FIG. 3, steps S306, S307, S313, and S316 are described separately for the sake of convenience. However, they can be implemented in one common step of determining which search mode a user has requested. Accordingly, if the user requests a search mode using given keywords, step S306 goes directly to step S308. If the user requests a search mode based on text input, step S306 goes directly to step S314. If the user requests a category search mode, step S306 goes directly to step S317.

According to the present invention as described above, information, such as proper nouns included in detailed information relating to provided broadcasting programs, is detected as a keyword, and a user uses detected keywords to search for information relating to a desired broadcasting program. Accordingly, a situation where no results are found is prevented. Also, when a user does not know or cannot determine a proper keyword in advance, information relating to a desired broadcasting program can be searched easily.

In addition, since a user has only to select a keyword to search for information relating to the desired broadcasting program, an information search according to the present invention is simple compared to existing related art searching methods.

Furthermore, any of an existing search mode based on text input, a search mode based on category selection, and a search mode according to the present invention can be selected by a user to search for information regarding a desired broadcasting program.

While the present invention has been particularly shown and described with reference to preferred embodiments thereof, it will be understood by those of ordinary skill in the art that various changes in form and details may be made therein without departing from the spirit and scope of the present invention as defined by the following claims.

What is claimed is:

1. A method of searching for information relating to broadcasting programs, comprising:
detecting at least one keyword for each of the broadcasting programs from received detailed information relating to the broadcasting programs; and
searching for a desired broadcasting program using the detected keyword.

2. The method of claim 1, wherein the at least one keyword is a proper noun.

3. The method of claim 1, wherein in the detecting step, information corresponding to proper nouns is detected as the at least one keyword from the received detailed information.

4. The method of claim 1, wherein the searching step comprises:
displaying a screen composed of the at least one keyword upon a request for a search for information relating to one of said broadcasting programs; and
searching for the received detailed information using a keyword selected from the at least one displayed keyword.

5. The method of claim 1, wherein the keyword detection step further comprises:
storing the received detailed information; and
storing the at least one detected keyword.

6. A method of searching for information relating to broadcasting programs, comprising:
receiving and storing detailed information relating to the broadcasting programs;
detecting at least one keyword for each of the broadcasting programs from the received detailed information, and storing the detected keywords;
searching for the received detailed information relating to desired one of said broadcasting programs, according to a search mode requested from among a search mode using the detected keywords, a text input search mode, and a category selection search mode; and
displaying the searched information relating to the broadcasting programs.

7. The method of claim 6, wherein the at least one keyword is a proper noun.

8. The method of claim 6, wherein if a search mode using the keywords is requested, the searching step comprises:
displaying all of the stored keywords; and
searching for the received detailed information using a keyword selected from the at least one displayed stored keyword.

9. An apparatus for searching for information relating to broadcasting programs, comprising:
a detailed information detector detecting detailed information relating to the broadcasting programs from a received broadcasting signal;
a keyword detector detecting at least one keyword from the detailed information detected by the detailed information detector;
a system controller controlling the keyword detector to output the at least one detected keyword if a search is requested for one of said broadcasting programs, displaying the keyword output from the keyword detector, and, if a keyword is selected from the at least one displayed keyword, displaying the detailed information relating to a broadcasting program including the selected keyword;
a graphics engine controlled by the system controller to transform the at least one detected keyword and the detected detailed information into information that can be displayed; and
a display unit displaying the at least one keyword and detailed information provided by the graphics engine.

10. The apparatus of claim 9, further comprising:
a first storage unit storing the detailed information; and
a second storage unit storing the at least one keyword.

11. The apparatus of claim 9, wherein the at least one keyword is a proper noun.

12. The apparatus of claim 9, wherein the keyword detector detects as the at least one keyword information corresponding to a proper noun from the detailed information.

13. An apparatus for searching for information relating to broadcasting programs, comprising:
a detailed information detector detecting detailed information relating to the broadcasting programs from a received broadcasting signal;
a keyword detector detecting at least one keyword from the detailed information detected by the detailed information detector;
a system controller controlling the apparatus so that information relating to a desired one of said broadcasting programs is searched from the detailed information according to a search mode requested by the user among a search mode using the detected keywords, a text input search mode, and a category selection search mode;
a graphics engine controlled by the system controller so that image data for the search mode using said at least one keyword, image data for the text input search mode, image data for the category search mode, and image data relating to searching results are each transformed into data that can be displayed; and
a display unit displaying the image data provided by the graphics engine.

14. The apparatus of claim 13, wherein results of said text input search mode are used for said search mode using said at least one keyword.

15. The apparatus of claim 13, wherein said system controller determines, one of sequentially and simultaneously, which of said search mode using the detected keywords, said text input search mode, and said category selection search mode has been selected.

16. The apparatus of claim 13, wherein a user requests a search to produce a desired one of said broadcasting programs.

17. The method of claim 6, further comprising applying results of said text input search mode for said search mode using said at least one keyword.

18. The method of claim 6, further comprising determining, one of sequentially and simultaneously, which of said search mode using the detected keywords, said text input search mode, and said category selection search mode has been selected.

19. The method of claim 6, wherein a user requests said searching to produce said desired broadcasting program.
